(19) United States
(12) Patent Application Publication
(10) Pub. No.: US 2024/0357445 A1
(43) Pub. Date: Oct. 24, 2024

(54) Master Node, Secondary Node, and Methods Performed in a Wireless Communication Network

(71) Applicant: Telefonaktiebolaget LM Ericsson (publ), Stockholm (SE)

(72) Inventors: Gautham Nayak Seetanadi, Stockholm (SE); Julien Muller, Rennes (FR)

(21) Appl. No.: 18/685,029

(22) PCT Filed: Aug. 10, 2022
(86) PCT No.: PCT/SE2022/050748

§ 371 Date: Feb. 20, 2024

Related U.S. Application Data
(60) Provisional application No. 63/235,216, filed on Aug. 20, 2021.

(51) Int. Cl. H04W 36/00

(52) U.S. Cl. CPC H04W 36/0083

(57) ABSTRACT

Embodiments herein relate to, for example, a method performed by a master node (12) for handling communication in a wireless communication network (1). The masternode obtains UHI related to a PCell of a user equipment, UE, (10), and further obtains, from a secondary node (13) further UHI related to a connected PSCell of the UE (10). The master node then correlates the obtained UHI and the obtained further UHI into a list of related PCells and PSCells.

### TECHNICAL FIELD

Embodiments herein relate to a master node (MN), a secondary node (SN) and methods performed therein regarding wireless communication. Furthermore, a computer program product and a computer-readable storage medium are also provided herein.

Especially, embodiments herein relate to handling or enabling communication, for example, handling user equipment history information (UHI) from a user equipment (UE) to a radio network node, in a wireless communication network.

### BACKGROUND

In a typical wireless communication network, UEs, also known as wireless communication devices, mobile stations, stations (STA) and/or wireless devices, communicate via a Radio access Network (RAN) to one or more core networks (CN). The RAN covers a geographical area which is divided into service areas or cell areas, with each service area or cell area being served by network node such as an access node e.g., a Wi-Fi access point or a radio base station (RBS), which in some radio access technologies (RAT) may also be called, for example, a NodeB, an evolved NodeB (eNodeB) and a gNodeB (gNB). The service area or cell area is a geographical area where radio coverage is provided by a radio network node. The radio network node operates on radio frequencies to communicate over an air interface with the wireless devices within range of the access node. The radio network node communicates over a downlink (DL) to the wireless device and the wireless device communicates over an uplink (UL) to the access node.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with UEs. In a forum known as the Third Generation Partnership Project (3GPP), telecommunications suppliers propose and agree upon standards for present and future generation networks and UTRAN specifically, and investigate enhanced data rate and radio capacity. In some RANs, e.g., as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3^{rd} Generation Partnership Project (3GPP) and this work continues in the coming 3GPP releases, such as 4G and 5G networks. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the emerging 5G technologies also known as new radio (NR), the use of very many transmit- and receive-antenna elements may be of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

Beamforming allows the signal to be stronger for an individual connection. On the transmit-side this may be achieved by a concentration of the transmitted power in the desired direction(s), and on the receive-side this may be achieved by an increased receiver sensitivity in the desired direction(s). This beamforming enhances throughput and coverage of the connection. It also allows reducing the interference from unwanted signals, thereby enabling several simultaneous transmissions over multiple individual connections using the same resources in the time-frequency grid, so-called multi-user Multiple Input Multiple Output (MIMO).

User equipment history information (UHI) was introduced in LTE and has been adopted in NR. A source radio network node collects and stores UHI for the duration when a UE is connected and stays in one of its cells.

The UHI collected by the radio network node varies depending upon whether it is NR or LTE, but they have similarities. The UHI may include cell identifier of a serving primary cell (PCell), the time UE stayed in the cell and a Handover (HO) cause. The maximum number of cells in UHI is capped at 16 entries.

The procedural text related to accumulation of UHI by the concerned NG-RAN node is found in Section 15.5.4 of TS 38.300 v16.0.0, and the corresponding ASN.1 can be found in IE UE History Information in section 9.3.1.95 of TS 38.413 v16.0.0. Abstract Syntax Notation (ASN; ASN1; ASN1) used herein, e.g. as code snippets, describes what information is/may be communicated in each referenced scenario.

The procedural text related to accumulation of UHI by the concerned eNB is found in Section 16.2.2.1 of TS 36.300, and the corresponding ASN.1 can be found in information element (IE) UE History Information in section 9.2.1.42 of TS 36.413 v16.0.0.

It should be noted that UHI differs from Mobility History Information (MHI). MHI is collected by the UE and then transferred to the network, whereas UHI is collected by the concerned radio network nodes.

Multi Radio-Dual Connectivity (MR-DC) describes the scenario where a UE that is capable of connecting to multiple radio network nodes utilizes the multiple resources to increase throughput as described in TS 37.340 v16.0.0. This is a generalization of the intra-E-UTRA Dual connectivity (DC) described in TS 36.300 v16.0.0.

When a UE is in DC mode, one radio network node acts as the Master node (MN) and the other radio network node acts as a Secondary node (SN). The MN and SN are connected via a network interface and at least the MN is connected to the core network. Details on MR-DC can be found in TS 38.401 v.16.0.0. The primary cell in MN is known as primary cell (PCell) and the primary cell in SN is known as primary secondary cell (PSCell).

In ongoing RAN3 discussions, the MN may collect UHI related to the PCell. Similarly, the SN may collect UHI related to the PSCell. Also in the discussions, the SN UHI is transferred to the MN and then correlated at the MN. The correlated complete UHI consists of a nested structure where the SN UHI is listed under the relevant MN UHI. Thus, a complete UHI structure for a UE consists of a list of PCell information and the associated PSCell information is listed under the relevant PCell.

The UE history information present at the MN consists of both PCell and PSCell information. The MN collects PCell information and edits this information in the correlated UHI. Similarly, the SN collects only PSCell information which is maintained independently and transferred to the MN.

As the lists are independently changed by the radio network nodes, the lists are correlated at the MN and may be accomplished through the IEs “time UE stayed in cell” or “time UE stayed in Cell Enhanced Granularity”.

The element “time UE stayed in Cell” has a range of (0 . . . 4095) seconds and “time UE Stayed in Cell Enhanced Granularity” has a range of (0 . . . 40950) tenth of seconds. On exceeding this limit, a maximum value is set. This makes PSCell and PCell correlation impossible in certain situations as described below. More information on the IEs can be found in section 9.3.1.95-97 in TS 38.413 v16.0.0.

### SUMMARY

Having a complex correlation or not so accurate correlation may affect the mobility of UEs and, thus, the performance of the wireless communication network may be limited or experienced as low.

An object of embodiments herein is to provide a mechanism that improves the performance in the wireless communication network.

According to an aspect the object is achieved by providing a method performed by a MN for handling communication such as handling UHIs in a wireless communication network. The MN obtains UHI related to a PCell of a UE, and obtains, from a secondary node further UHI related to a connected PSCell of the UE. The MN then correlates the obtained UHI and the obtained further UHI into a list of related PCells and PSCells.

According to embodiments herein, the MN may base the correlation on:
A time stamp in the two UHIs
An optional time stamp that is only used when the “time UE stayed in cell” exceeds the predetermined range
Repeating entries on exceeding the range of “time UE stayed in cell”
An optional time stamp that is only used when the “time UE stayed in cell” exceeds the predetermined range and SN release time.
A new “Time UE stayed in cell extended” IE with an extended range.

According to another aspect the object is achieved by providing a method performed by a SN for handling communication such as handling UHIs in a wireless communication network. The SN obtains UHI related to a connected PSCell of a UE, and provides to a MN the obtained UHI for the UE. The SN may add one or more of the following into the UHI:
A time stamp in the UHI
An optional time stamp that is only used when the “time UE stayed in cell” exceeds the predetermined range
Repeating entries on exceeding the range of “time UE stayed in cell”
An optional time stamp that is only used when the “time UE stayed in cell” exceeds the predetermined range and SN release time.
A new “Time UE stayed in cell extended” IE with an extended range.

According to still another aspect the object is achieved by providing a MN and a SN configured to perform the methods herein.

Thus, it is herein provided a MN for handling communication in a wireless communication network. The MN is configured to obtain UHI related to a PCell of a UE, and to obtain, from a secondary node, further UHI related to a connected PSCell of the UE. The MN is further configured to correlate the obtained UHI and the obtained further UHI into a list of related PCells and PSCells

Furthermore, it is herein provided a SN for handling communication in a wireless communication network. The SN is configured to obtain UHI related to a connected PSCell of a UE, and to provide to a MN the obtained UHI for the UE.

It is furthermore provided herein a computer program product comprising instructions, which, when executed on at least one processor, cause the at least one processor to carry out any of the methods herein, as performed by the MN or the SN, respectively. It is additionally provided herein a computer-readable storage medium, having stored thereon a computer program product comprising instructions which, when executed on at least one processor, cause the at least one processor to carry out any of the methods herein, as performed by the MN or the SN, respectively.

The proposed solution allows for correlation of PCell and PSCell information at the MN, for example, through the use of time stamps, time UE stayed in cell and/or both. Currently there exist no strategies for correlation of PCell and PSCell information at the MN. One option also allows for correlation of PCell and PSCell information without the need for synchronization between the two network nodes. Thus, embodiment herein may provide a mechanism that improves the performance in the wireless communication network.

### BRIEF DESCRIPTION OF THE DRAWINGS

Embodiments will now be described in more detail in relation to the enclosed drawings, in which:

FIG. 1 is a schematic overview depicting a wireless communication network according to embodiments herein;

FIG. 2 is a combined signalling scheme and flowchart according to embodiments herein;

FIG. 3 is a combined flowchart according to embodiments herein;

FIG. 4 is a flowchart depicting a method performed by a MN according to embodiments herein;

FIG. 5 is a flowchart depicting a method performed by a SN according to embodiments herein;

FIG. 6 is a block diagram depicting MNs according to embodiments herein;

FIG. 7 is a block diagram depicting SNs according to embodiments herein;

FIG. 8 schematically illustrates a telecommunication network connected via an intermediate network to a host computer;

FIG. 9 is a generalized block diagram of a host computer communicating via a base station with a user equipment over a partially wireless connection; and

FIGS. 10-13 are flowcharts illustrating methods implemented in a communication system including a host computer, a base station and a user equipment.

### DETAILED DESCRIPTION

Embodiments herein are described within the context of 3GPP NR radio technology (3GPP TS 38.300 V15.2.0 (2018-06)). It is understood, that the problems and solutions described herein are equally applicable to wireless access networks and user-equipments (UEs) implementing other access technologies and standards. NR is used as an example technology where embodiments are suitable, and using NR in the description therefore is particularly useful for understanding the problem and solutions solving the problem. In particular, embodiments are applicable also to 3GPP LTE, or 3GPP LTE and NR integration, also denoted as non-standalone NR.

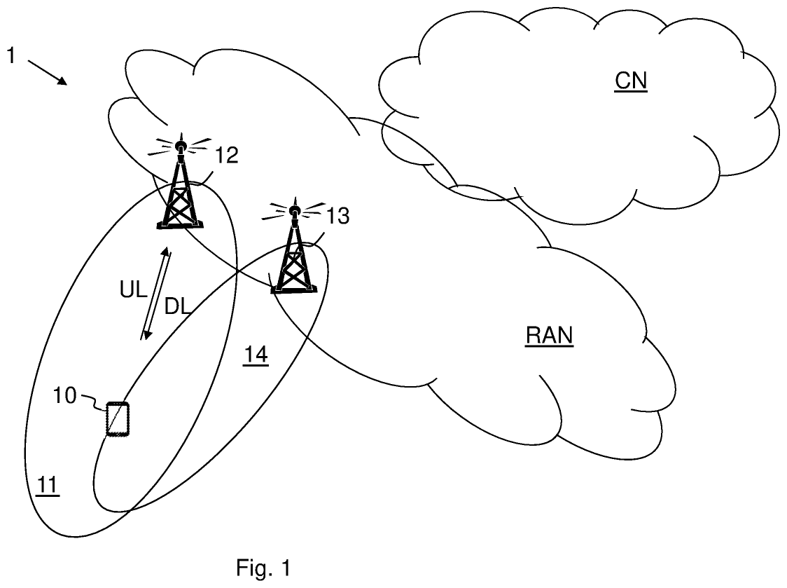

Embodiments herein relate to wireless communication networks in general. FIG. 1 is a schematic overview depicting a wireless communication network 1. The wireless communication network 1 comprises one or more RANs and one or more CNs. The wireless communication network 1 may use one or a number of different technologies, such as Wi-Fi, Long Term Evolution (LTE), LTE-Advanced, Fifth Generation (5G), Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

In the wireless communication network 1, wireless devices e.g. a UE 10 such as a mobile station, a non-access point (non-AP) STA, a STA, a user equipment and/or a wireless terminal, communicate via one or more Access Networks (AN), e.g. RAN, to one or more core networks (CN). It should be understood by the skilled in the art that “UE” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station capable of communicating using radio communication with a network node within an area served by the network node.

The wireless communication network 1 comprises a first radio network node 12 providing radio coverage over a geographical area, a first service area 11, of a radio access technology (RAT), such as LTE, Wi-Fi, WiMAX or similar. The radio network node 12 may be a transmission and reception point e.g. a radio network node such as a Wireless Local Area Network (WLAN) access point or an Access Point Station (AP STA), an access node, an access controller, a base station, e.g. a radio base station such as a NodeB, an evolved Node B (eNB, eNode B), a gNodeB (gNB), a base transceiver station, a radio remote unit, an Access Point Base Station, a base station router, a transmission arrangement of a radio base station, a stand-alone access point or any other network unit or node capable of communicating with a UE within the area served by the first network node 12 depending e.g. on the radio access technology and terminology used. The radio network node 12 may alternatively or additionally be a controller node or a packet processing node such as a radio controller node or similar. The first radio network node 12 may be referred to as a serving network node or master node (MN) 12 wherein the first cell may be referred to as a serving cell or primary cell (PCell), and the serving network node communicates with the UE 10 in form of DL transmissions to the UE 10 and UL transmissions from the UE 10.

The wireless communication network 1 comprises a second radio network node 13 providing radio coverage over a geographical area, a second service area 14, of a radio access technology (RAT), such as LTE, Wi-Fi, WiMAX or similar. The radio network node 13 may be a transmission and reception point e.g. a radio network node such as a Wireless Local Area Network (WLAN) access point or an Access Point Station (AP STA), an access node, an access controller, a base station, e.g. a radio base station such as a NodeB, an evolved Node B (eNB, eNode B), a gNodeB (gNB), a base transceiver station, a radio remote unit, an Access Point Base Station, a base station router, a transmission arrangement of a radio base station, a stand-alone access point or any other network unit or node capable of communicating with a UE within the area served by the second radio network node 13 depending e.g. on the radio access technology and terminology used. The second radio network node 13 may alternatively or additionally be a controller node or a packet processing node such as a radio controller node or similar. The second radio network node 13 may be referred to as a secondary node (SN) 13 or secondary serving network node wherein the second service area may be referred to as a secondary serving cell or primary secondary cell (PSCell), and the SN communicates with the UE 10 in form of DL transmissions to the UE 10 and UL transmissions from the UE 10 in DC.

It should be noted that a service area may be denoted as cell, beam, beam group or similar to define an area of radio coverage.

A new IE “time stamp” in the SN UHI may be useful for correlation. The above problem exists however without a time stamp in the MN UHI as well. Also, using a timestamp instead of the legacy “time UE stayed in Cell” would need time synchronization between MN and SN if the MN needs to perform the correlation between the PCell list and the PSCell list. Embodiments herein allow the MN to choose the right PCell entry under which the obtained PSCell entries are entered.

This may be accomplished through five different options,
Option A: A time stamp in the two UHIs
Option B: An optional time stamp that is only used when the “time UE stayed in cell” exceeds the predetermined range
Option C: Repeating entries on exceeding the range of “time UE stayed in cell”. Repeating entries in UHI means multiple contiguous PSCell entries with the same PSCell ID under the same PCell entry. The first PSCell entry(ies) having the “time UE stayed in cell” parameter set to the maximum value. The last entry having “time UE stayed in cell” parameter set to the remaining time the UE stayed in this PSCell.
Option D: An optional time stamp that is only used when the “time UE stayed in cell” exceeds the predetermined range and SN release time.
Option E: A new “Time UE stayed in cell extended” IE with an extended range.

The proposed solution allows for correlation of PCell and PSCell information at the MN through, for example, the use of time stamps, time UE stayed in cell and/or both. Currently there exist no strategies for correlation of PCell and PSCell information at the MN. One option also allows for correlation of PCell and PSCell information without the need for synchronization between the two network nodes. Thus, embodiment herein may provide a mechanism that improves the performance in the wireless communication network.

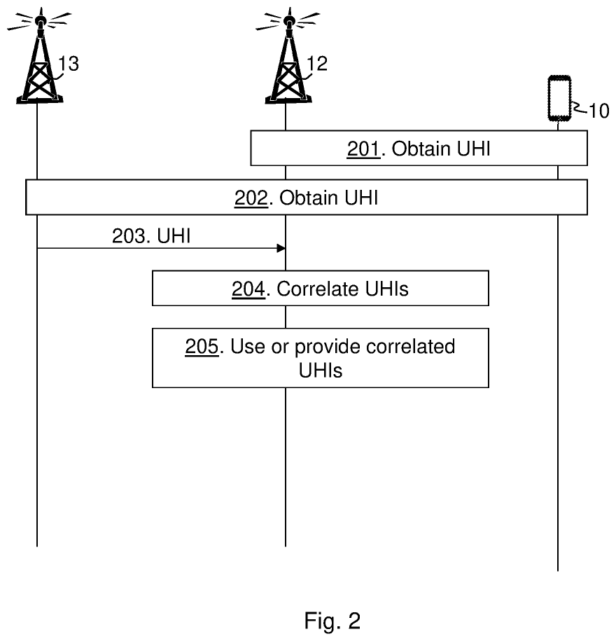

FIG. 2 is a combined flowchart and signalling scheme according to embodiments herein. The actions may be performed in any suitable order.

Action 201. The MN 12 obtains UHI of one or more cells.

Action 202. The SN 13 obtains UHI of one or more cells.

Action 203. The SN 13 then provides the obtained UHI to the MN 12 periodically or upon request.

Action 204. The MN 12 correlates the obtained UHIs into a correlated list of UHIs of different cells for the UE 10. According to some embodiments herein time stamps, optional time stamp, repeating entries, and extended IEs may be used for the correlation.

Action 205. The MN 12 may then use the correlated list to improve mobility. For example, choose preferred combination of PCell and PSCell for good coverage, and/or may find problems with some cell combinations. The MN 12 may decide whether to perform dual connectivity or not for the UE 10 based on the correlated list. The MN 12 may provide the correlated list to another network node for handling mobility of the UE 10.

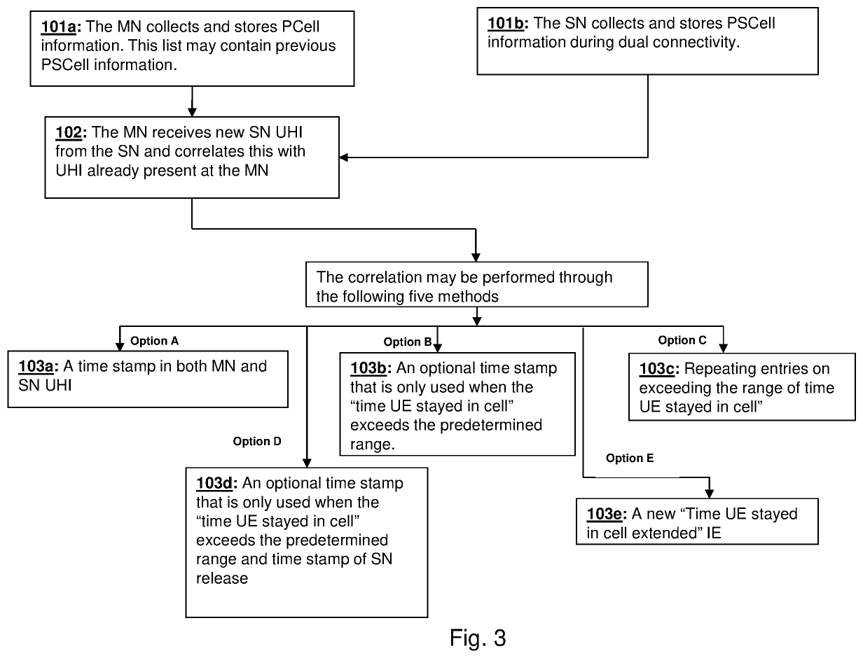

FIG. 3 is a combined flowchart and signalling scheme according to an exemplary embodiment herein. The actions may be performed in any suitable order.

Action 101a: The master node 12 collects and stores PCell information of each UE in list(s). This list may consist of previously obtained PSCell information listed under the appropriate PCell information. Each entry of the PCell contains an IE “time spent by UE in Cell” is capped at a value X seconds, exceeding which it is set to X.

Action 101b: The secondary node 13 collects and stores the PSCell information of each UE as a list. This list may contain old entries sent by the PCell during SN addition. The SN modifies this list with information obtained during Dual Connectivity operations. Like Pcell entries, each entry of the PSCell contains an IE “time spent by UE in Cell” is capped at a value Y seconds, exceeding which it is set to Y. This list is then transmitted to the MN 12 for correlation with PCell entries.

Action 102: When the MN 12 receives the PSCell list from the SN 13, it has to separate the PSCell entries and insert them appropriately into the PCell entry corresponding to the time at which both were active, i.e., the MN 12 correlates the UHIs. This may be done through different solutions.

Option A: A time stamp in both MN UHI and SN UHI

Action 103a: The MN 12 compares the time stamp in PCell list with the time stamp in the received PSCell list and evaluates which PCell and PSCell the UE 10 was connected to at the same time and inserts the PSCell entry/entries under the appropriate PCell entry/entries. This can lead to different scenarios
All PSCell entries with time stamps that lie between an older and newer PCell timestamp are inserted into the older PCell entry.
If all PSCell entries have a time stamp newer than the newest PCell entry, then all PSCell entries are inserted into the last/newest PCell entry.
If all PSCell entries have a time stamp older than the oldest PCell entry, then the newest PSCell entry is inserted into all PCell entries. The rest of the PSCell entries are discarded.

Option B: An optional time stamp that is only used when the “time UE stayed in cell” exceeds the predetermined range.

Action 103b: The MN 12 and SN 13 insert an optional timestamp in PCell/PSCell entries respectively. This is done independently by the MN 12 when a UE stayed in a PCell for longer than the pre-determined range X “time UE stayed in Cell”.

Similarly, the SN 13 inserts an optional time stamp in the PSCell information when the UE 10 stayed in a PSCell for longer than the pre-determined range Y “time UE stayed in Cell”.

The MN 12 then performs the following for UHI correlation when the SN UHI is obtained.
The MN 12 uses a combination of “time UE stayed in cell” and the time stamp to obtain the actual time spent by the UE in the cell.
The MN 12 then performs action performed in action 103a to correlate PCell and PSCell information.

Option C: Repeating entries on exceeding the range of X/Y “time UE stayed in cell”

Action 103c: On exceeding the range IE “time UE stayed in Cell” or “time UE stayed in Cell Enhanced Granularity” either in the MN 12 or SN 13, the appropriate entry is repeated with a new “time UE stayed in Cell”. This information can then be used to correlate

Option D: An optional time stamp that is only used when the “time UE stayed in cell” exceeds the predetermined range and the SN release time.

Action 103d: The MN 12 and SN 13 insert an optional timestamp in PCell/PSCell entries respectively. This is done independently by the MN 12 when the UE 10 stayed in a PCell for longer than the pre-determined range X “time UE stayed in Cell”. The timestamp corresponds to the time when a successful connection is established.

Similarly, the SN 13 inserts an optional time stamp in the PSCell information when the UE 10 stayed in a PSCell for longer than the pre-determined range Y “time UE stayed in Cell” and a PSCell change occurs. The time stamp corresponds to the time of PSCell connection.

The MN 12 may then independently calculate the actual time spent in each cell without the need for synchronization between the two nodes.

Option E: A new “Time UE stayed in cell extended” IE with an extended range.

Action 103e: The UHI has new IE that has an extended range compared to the legacy to allow for larger time periods. This new IE will be inserted only if the UE 10 stayed in a PSCell for longer than the pre-determined range Y “time UE stayed in Cell”.

Thus, embodiments herein assume a dual connection scenario with the UE 10 connected to the MN 12 and the SN 13. As the UE 10 is connected to different PCell and PSCells, the MN 12 and SN 13 collects the relevant information independently. After a certain time, the MN 12 will have a list with PCell information, and the SN 13 will have a list of PSCell information. Below lists show an example with combinations of where the UE 10 has stayed for small and long time and exceeded the “time UE stayed in cell” has exceeded the time. The cells for which time is exceeded is indicated by * for better understanding.

The UE 10 connects to a series of PCell entries for the following time:
Pcell A: From time 10:00:00 to 10:50:00
Pcell B: From time 10:50:00 to 12:00:00
Pcell C: From time 12:00:00 to 12:40:00
Pcell B: From time 12:40:00 to time of correlation (12:50:00)

During the same time, the UE 10 is connected to the following PSCells:
PSCell A: From time 10:00:00 to 10:02:00
PSCell B: From time 10:02:00 to 10:42:00
PSCell C: From time 10:42:00 to 12:10:00
PSCell A: From time 12:10:00 to SN release at time 12:40:00

The MN and SN list cell information independently as shown below,

| | Time UE | | Time UE |
|---|---|---|---|
| | stayed in | | stayed in |
| PCell ID | PCell(s) | PSCell ID | PSCell(s) |
| PCell A | 3000 | PSCell A | 100 |
| PCell B | 4095* | PSCell B | 2000 |
| PCell C | 2400 | PSCell C | 4095* |
| PCell B | 600 | PSCell A | 1200 |

The list above is then correlated using the different options as described in Section 3:

Option A: The MN 12 and SN 13 may insert timestamps into each entry indicating the time of successful cell connection. This can be used to then correlate.

| | Time UE stayed | Time stamp of |
|---|---|---|
| PCell ID | in PCell(s) | connection |
| PCell A | 3000 | 10:00:00 |
| PCell B | 4095* | 10:50:00 |
| PCell C | 2400 | 12:00:00 |
| PCell B | 600 | 12:40:00 |
| | Time UE stayed | Time stamp of |
| PSCell ID | in PSCell(s) | connection |
| PSCell A | 120 | 10:00:00 |
| PSCell B | 2400 | 10:02:00 |
| PSCell C | 4095* | 10:42:00 |
| PSCell A | 1200 | 12:10:00 |

The MN 12 builds the correlated PCell PSCell list as follows when the SN 13 sends the PSCell information.

| Correlated PCell | Time UE stayed | Time stamp of |
|---|---|---|
| PSCell | in PCell(s) | connection |
| PCell A | 3000 | 10:00:00 |
| >PSCell A | 120 | 10:00:00 |
| >PSCell B | 2400 | 10:02:00 |
| >PSCell C | 4095* | 10:42:00 |
| PCell B | 4095* | 10:50:00 |
| >PSCell C | 4095* | 10:42:00 |
| PCell C | 2400 | 12:00:00 |
| >PSCell C | 4095* | 10:42:00 |
| >PSCell A | 1200 | 12:10:00 |
| PCell B | 600 | 12:40:00 |
| >PSCell A | 1200 | 12:10:00 |

Option B: The SN 13 inserts timestamps into entries that exceed the time UE stayed.

| | Time UE stayed |
|---|---|
| PCell ID | in PCell(s) |
| PCell A | 3000 |
| PCell B | 4095* |
| PCell C | 2400 |
| PCell B | 600 |

| | Time UE stayed | |
|---|---|---|
| PSCell ID | in PSCell(s) | timestamp |
| PSCell A | 100 | |
| PSCell B | 2000 | |
| PSCell C | 4095* | 10:42:00 |
| PSCell A | 1200 | |

The MN 12 may correlate the UHIs of the PCells and PSCells by using the optional time stamp and time at MN 12 to build the correlated UHI.

| Correlated PCell | Time UE stayed |
|---|---|
| PSCell | in PCell(s) |
| PCell A | 3000 |
| >PSCell A | 120 |
| >PSCell B | 2400 |
| >PSCell C | 4095 |
| PCell B | 4095* |
| >PSCell C | 4095* |
| PCell C | 2400 |
| >PSCell C | 4095* |
| >PSCell A | 1200 |
| PCell B | 600 |
| >PSCell A | 1200 |

Option C: The MN 12 and SN 13 may repeat entries when the IE exceeds the limit of 4095.

| | Time UE stayed | | Time UE stayed |
|---|---|---|---|
| PCell ID | in PCell(s) | PSCell ID | in PSCell(s) |
| PCell A | 3000 | PSCell A | 100 |
| PCell B | 4095 | PSCell B | 2000 |
| PCell B | 105 | PSCell C | 4095 |
| PCell C | 2400 | PSCell C | 585 |
| PCell B | 600 | PSCell A | 1200 |

The MN 12 may correlate the UHIs of the PCells and PSCells by using the time stayed by the UE 10 as follows,

| Correlated PCell | Time UE stayed |
|---|---|
| PSCell | in PCell(s) |
| PCell A | 3000 |
| >PSCell A | 120 |
| >PSCell B | 2400 |
| >PSCell C | 4095 |
| PCell B | 4095 |
| >PSCell C | 4095 |
| >PSCell C | 585 |
| PCell B | 105 |
| >PSCell C | 585 |
| PCell C | 2400 |
| >PSCell C | 585 |
| >PSCell A | 1200 |
| PCell B | 600 |
| >PSCell A | 1200 |

Option D: The SN 13 may insert timestamps into entries that exceed the time UE stayed. The timestamp corresponds to time of successful connection. The SN 13 also inserts the timestamp of SN release. This does not require clock synchronization between the two nodes.

| | Time UE stayed | Optional time |
|---|---|---|
| PCell ID | in PCell(s) | stamp |
| PCell A | 3000 | |
| PCell B | 4095* | 10:50:00 |
| PCell C | 2400 | |
| PCell B | 600 | |

time of correlation at MN: 12:50:00

| | Time UE stayed | Optional time |
|---|---|---|
| PSCell ID | in PSCell(s) | stamp |
| PSCell A | 100 | |
| PSCell B | 2000 | |
| PSCell C | 4095* | 10:42:00 |
| PSCell A | 1200 | |

SN release time: 12:30:00

The SN 13 transmits the SN release time to the MN 12 and the MN 12 may use this to get actual time spent in each cell for correlation with the following formulas:

For entries in PCell list: Actual time in cell=time of correlation at MN—optional time stamp—time stayed in all future cells.

For entries in PSCell list: Actual time in cell=SN release time—optional time stamp—time stayed in all future cells.

| | Time UE stayed | Optional time | Actual time |
|---|---|---|---|
| PCell ID | in PCell (s) | stamp | in cell (s) |
| PCell A | 3000 | | |
| PCell B | 4095* | 10:50:00 | 4200 |
| PCell C | 2400 | | |
| PCell B | 600 | | |
| | Time UE stayed | Optional time | Actual time |
| PSCell ID | in PSCell(s) | stamp | in Cell(s) |
| PSCell A | 100 | | |
| PSCell B | 2000 | | |
| PSCell C | 4095* | 10:42:00 | 5280 |
| PSCell A | 1200 | | |

The MN 12 may then use the information to build correlated UHIs similar to Option B.

### Possible Implementations of the Different Options for Correlation

### Option B Possible Implementations:

Below it is shown a possible implementation of the method described for option B, bold text. In this example, the Last Visited NG-RAN Cell Information IE found in TS 38.413 is extended with an optional timestamp.

### 9.3.1.97 Last Visited NG-RAN Cell Information

This IE contains information about a cell. In case of NR cell, this IE contains information about a set of NR cells with the same NR Absolute Radio-Frequency Channel Number (ARFCN) for reference point A, and the Global Cell ID IE identifies one of the NR cells in the set. The information is to be used for radio resource management (RRM) purposes.

| | | | | |
|---|---|---|---|---|
| | | | IE type and | |
| IE/Group Name | Presence | Range | reference | Semantics description |

| | | | |
|---|---|---|---|
| Global Cell ID | M | NG-RAN CGI | |
| | | 9.3.1.73 | |
| Cell Type | M | 9.3.1.98 | |
| Time UE Stayed in Cell | M | INTEGER | The duration of time the |
| | | (0 . . . 4095) | UE stayed in the cell, or set |
| | | | of NR cells with the same |
| | | | NR ARFCN for reference |
| | | | point A, in seconds. If the |
| | | | duration is more than |
| | | | 4095 s, this IE is set to |
| | | | 4095 |
| Time UE Stayed in Cell | O | INTEGER | The duration of time the |
| Enhanced Granularity | | (0 . . . 40950) | UE stayed in the cell, or set |
| | | | of NR cells with the same |
| | | | NR ARFCN for reference |
| | | | point A, in 1/10 seconds. If |
| | | | the duration is more than |
| | | | 4095 s, this IE is set to |
| | | | 40950. |
| HO Cause Value | O | Cause | The cause for the |
| | | 9.3.1.2 | handover. |
| PSCell change | O | OCTET STRING | UTC time encoded in the |
| timestamp | | (SIZE(4)) | same format as the first |
| | | | four octets of the 64-bit |
| | | | timestamp format as |
| | | | defined in section 6 of |
| | | | IETF RFC 5905 [14]. It |
| | | | indicates the time of the |
| | | | successful UE |
| | | | connection to the PSCell |
| | | | identified by the Global |
| | | | Cell ID. |

In another possible implementation, this additional timestamp can be added to a new Last Visited NG-RAN PSCell Information IE.

### Option D Possible Implementations:

Below it is shown a possible implementation of the method described for option D, bold text. In this example, the UE History Information IE found in TS 38.413 is extended with an optional timestamp of SN release. Similarly, the Last Visited NG-RAN Cell Information IE found in TS 38.413 is extended with an optional timestamp of Cell change.

### 9.3.1.97 Last Visited NG-RAN Cell Information

This IE contains information about a cell. In case of NR cell, this IE contains information about a set of NR cells with the same NR ARFCN for reference point A, and the Global Cell ID IE identifies one of the NR cells in the set. The information is to be used for RRM purposes.

| | | | | |
|---|---|---|---|---|
| | | | IE type and | Semantics |
| IE/Group Name | Presence | Range | reference | description |

| | | | |
|---|---|---|---|
| Global Cell ID | M | NG-RAN CGI | |
| | | 9.3.1.73 | |
| Cell Type | M | 9.3.1.98 | |
| Time UE Stayed in Cell | M | INTEGER | The duration of time the |
| | | (0 . . . 4095) | UE stayed in the cell, or |
| | | | set of NR cells with the |
| | | | same NR ARFCN for |
| | | | reference point A, in |
| | | | seconds. If the duration |
| | | | is more than 4095 s, |
| | | | this IE is set to 4095. |
| Time UE Stayed in Cell | O | INTEGER | The duration of time the |
| Enhanced Granularity | | (0 . . . 40950) | UE stayed in the cell, or |
| | | | set of NR cells with the |
| | | | same NR ARFCN for |
| | | | reference point A, in |
| | | | 1/10 seconds. If the |
| | | | duration is more than |
| | | | 4095 s, this IE is set to |
| | | | 40950. |
| HO Cause Value | O | Cause | The cause for the |
| | | 9.3.1.2 | handover. |
| PSCell change | O | OCTET STRING | UTC time encoded in |
| timestamp | | (SIZE(4)) | the same format as |
| | | | the first four octets of |
| | | | the 64-bit timestamp |
| | | | format as defined in |
| | | | section 6 of IETF RFC |
| | | | 5905 [14]. It indicates |
| | | | the time of the |
| | | | successful UE |
| | | | connection to the |
| | | | PSCell identified by |
| | | | the Global Cell ID. |

In another possible implementation, this additional PSCell change timestamp can be added to a new Last Visited NG-RAN PSCell Information 1E.

### 9.3.1.95 UE History Information

This IE contains information about cells that a UE has been served by in active state prior to the target cell.

| | | | IE type and | Semantics |
|---|---|---|---|---|
| IE/Group Name | Presence | Range | reference | description |
| Last Visited Cell Item | | 1 . . . | | Most recent information |
| | | <maxnoofCellsinUEHistory | | is added to the top of |
| | | Info> | | this list. |
| >Last Visited Cell | M | | 9.3.1.96 | |
| Information | | | | |
| > Release timestamp | O | | OCTET STRING | UTC time encoded in |
| | | | (SIZE(4)) | the same format as the |
| | | | | first four octets of the |
| | | | | 64-bit timestamp format |
| | | | | as defined in section 6 |
| | | | | of IETF RFC 5905 [14]. |
| | | | | It indicates the time of |
| | | | | SN release. |

In another possible implementation, the additional release timestamp can be added to new Last Visited NG-RAN PSCell Information IE, or new SN UE History Information. The additional timestamp may also be added to Last Visited Cell Information IE found in TS 38.413.

### Option E Possible Implementations:

Below it is shown a possible implementation of the method described for option C, bold text. In this example, the Last Visited NG-RAN Cell Information IE found in TS 38.413 is extended with an optional Time UE Stayed in Cell extended IE.

### 9.3.1.97 Last Visited NG-RAN Cell Information

This IE contains information about a cell. In case of NR cell, this IE contains information about a set of NR cells with the same NR ARFCN for reference point A, and the Global Cell ID IE identifies one of the NR cells in the set. The information is to be used for RRM purposes.

| | | | | |
|---|---|---|---|---|
| | | | IE type and | Semantics |
| IE/Group Name | Presence | Range | reference | description |

| | | | |
|---|---|---|---|
| Global Cell ID | M | NG-RAN CGI | |
| | | 9.3.1.73 | |
| Cell Type | M | 9.3.1.98 | |
| Time UE Stayed in Cell | M | INTEGER | The duration of time the |
| | | (0 . . . 4095) | UE stayed in the cell, or |
| | | | set of NR cells with the |
| | | | same NR ARFCN for |
| | | | reference point A, in |
| | | | seconds. If the duration |
| | | | is more than 4095 s, |
| | | | this IE is set to 4095. |
| Time UE Stayed in Cell | O | INTEGER | The duration of time the |
| Enhanced Granularity | | (0 . . . 40950) | UE stayed in the cell, or |
| | | | set of NR cells with the |
| | | | same NR ARFCN for |
| | | | reference point A, in |
| | | | 1/10 seconds. If the |
| | | | duration is more than |
| | | | 4095 s, this IE is set to |
| | | | 40950. |
| HO Cause Value | O | Cause | The cause for the |
| | | 9.3.1.2 | handover. |
| Time UE Stayed in Cell | O | INTEGER | If present, the Time |
| Extended | | (4096 . . . 86400) | UE Stayed in Cell IE |
| | | | shall be ignored. |
| | | | The duration of time |
| | | | the UE stayed in the |
| | | | cell, or set of NR cells |
| | | | with the same NR |
| | | | ARFCN for reference |
| | | | point A, in seconds, if |
| | | | this time is greater |
| | | | than 4095 s. If the |
| | | | duration is more than |
| | | | 86400 s, this IE is set |
| | | | to 86400. |

In another possible implementation, this additional PSCell change timestamp can be added to a new Last Visited NG-RAN PSCell Information IE.

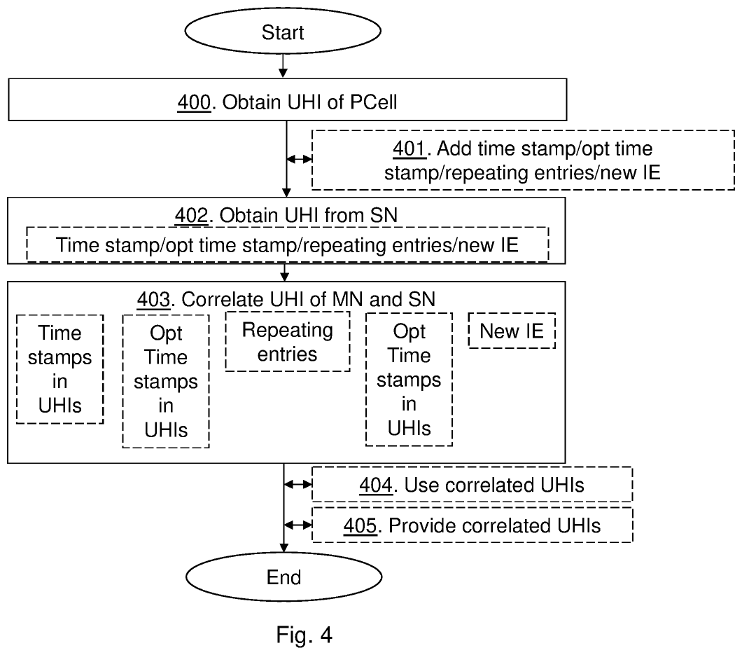

The method actions performed by the MN 12 for handling communication or UHIs in the wireless communication network 1 according to embodiments will now be described with reference to a flowchart depicted in FIG. 4. The actions do not have to be taken in the order stated below, but may be taken in any suitable order. Actions performed in some embodiments are marked with dashed boxes.

Action 400. The MN 12 obtains the UHI related to the PCell of the UE 10. The MN 12 may obtain UHI of PCell information and/or PSCell information.

Action 401. The MN 12 may add the time stamp in the UHI; the optional time stamp that is only used when a time UE stayed in cell-IE exceeds the predetermined range; the repeating entries on exceeding a range of time UE stayed in cell-IE; the optional time stamp that is only used when the time UE stayed in cell-IE exceeds the predetermined range and a SN release time; and/or the time UE stayed in cell extended-IE with the extended range.

Action 402. The MN 12 obtains from the SN 13 further UHI related to the connected PSCell of the UE 10. The MN 12 may obtain UHI of PSCell information and/or PCell information. The obtained further UHI may comprise the time stamp in the further UHI; the optional time stamp that is only used when a time UE stayed in cell-IE exceeds the predetermined range; the repeating entries on exceeding a range of time UE stayed in cel-” IE; the optional time stamp that is only used when the time UE stayed in cell-IE exceeds the predetermined range and a SN release time; and/or the time UE stayed in cell extended-IE with the extended range.

Action 403. The MN 12 then correlates the obtained UHI and the obtained further UHI into a list of related (or connected) PCells and PSCells. Thus, the MN 12 may correlate the PCell list with PSCell such that PSCells that are served the UE 10 at the same time as the PCell are together in the correlated list.

According to embodiments herein, the MN 12 may base the correlation on:
the time stamp in the UHIs. A time stamp in the two UHIs
the optional time stamp that is only used when the “time UE stayed in cell”-IE exceeds the predetermined range
the repeating entries on exceeding the range of “time UE stayed in cell”-IE
the optional time stamp that is only used when the “time UE stayed in cell”-IE exceeds the predetermined range and the SN release time.
the “Time UE stayed in cell extended” IE with the extended range.

Thus, depending on which the MN 12 and/or the SN may add these time stamp, optional time stamp, repeating entries, and/or new IE when collecting the UHIs (shown in dashed boxes in action 401 and 402). The obtained UHIs may comprise time stamp, optional time stamp, repeating entries, and/or new IE.

Action 404. The MN 12 may then use the correlated list for handling communication, such as mobility, DC or similar, of the UE 10. The MN 12 may use the correlated list to improve mobility for the UE 10 or other UEs. For example, choose preferred combination of PCell and PSCell for good coverage, and/or may find problems with some cell combinations. The MN may decide whether to perform dual connectivity or not for the UE 10 based on the correlated list.

Action 405. The MN 12 may provide the correlated list to another network node for handling mobility of the UE 10.

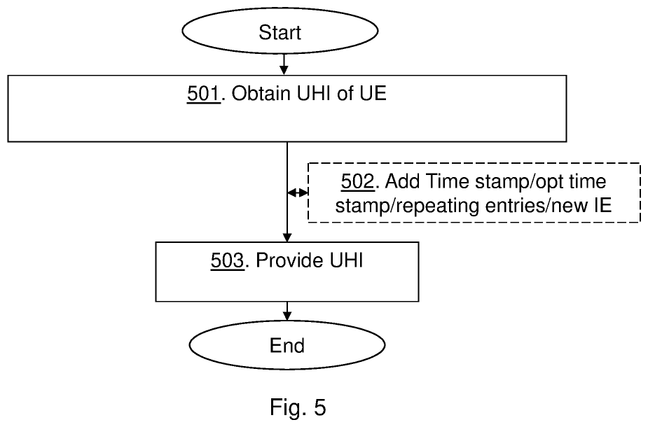

The method actions performed by the SN 13 for handling communication or UHIs in the wireless communication network 1 according to embodiments will now be described with reference to a flowchart depicted in FIG. 5. The actions do not have to be taken in the order stated below, but may be taken in any suitable order. Actions performed in some embodiments are marked with dashed boxes.

Action 501. The SN 13 obtains UHI related to the connected PSCell of the UE 10.

For example, the SN 13 may obtain UHIs of connected PCells and PSCells for one or more UEs.

Action 502. The SN 13 may add into the UHI:
the time stamp in the UHI
the optional time stamp that is only used when the “time UE stayed in cell”-IE exceeds the predetermined range
the repeating entries on exceeding the range of “time UE stayed in cell”-IE
the optional time stamp that is only used when the “time UE stayed in cell”-IE exceeds the predetermined range and the SN release time.
the “Time UE stayed in cell extended-IE with the extended range.

Action 503. The SN 13 then provides to the MN 12 the obtained UHI for the UE, also referred to as further UHI. The SN 13 may provide the UHI for one or more UEs comprising time stamp, optional time stamp, repeating entries, and/or new IE. The may UHI comprise one or more of the following:
the time stamp in the UHI:
the optional time stamp that is only used when a time UE stayed in cell-information element, IE, exceeds the predetermined range;
the repeating entries on exceeding a range of time UE stayed in cell-IE; the optional time stamp that is only used when the time UE stayed in cell-IE exceeds the predetermined range and a SN release time; and the time UE stayed in cell extended-IE with an extended range

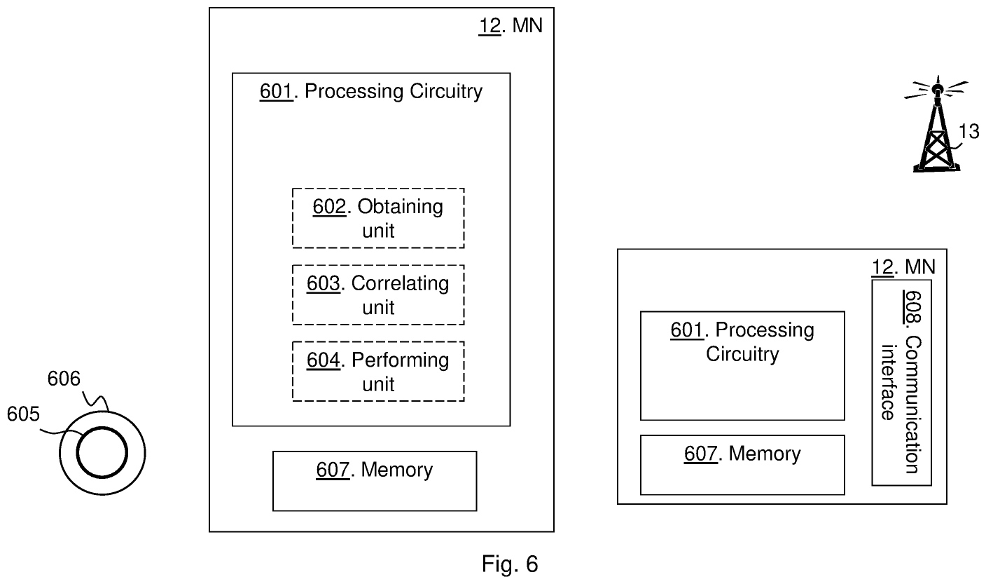

FIG. 6 is a block diagram depicting MN 12 in two embodiments for handling communication, e.g., handling UHIs, in the wireless communication network 1 according to embodiments herein.

The MN 12 may comprise processing circuitry 601, e.g. one or more processors configured to perform the methods herein.

The MN 12 may comprise an obtaining unit 602, e.g. a receiver, collector, or a transceiver. The MN 12, the processing circuitry 601, and/or the obtaining unit 602 is configured to obtain UHI related to the PCell, of the UE 10. The MN 12, the processing circuitry 601, and/or the obtaining unit 602 is further configured to obtain from the SN 13 further UHI related to the connected PSCell of the UE 10. For example, the MN 12, the processing circuitry 601, and/or the obtaining unit 602 may be configured to obtain UHI of PCell information and/or PSCell information of the MN 12, and to obtain from the SN 13 UHI of PSCell information and/or PCell information of the SN 13.

The MN 12 may comprise a correlating unit 603. The MN 12, the processing circuitry 601, and/or the correlating unit 603 is configured to correlate the obtained UHI and the obtained further UHI into the list of related (or connected) PCells and PSCells.

The MN 12, the processing circuitry 601, and/or the correlating unit 603 may be configured to correlate the UHIs into the list of connected PCells and PSCells.

The MN 12, the processing circuitry 601, and/or the correlating unit 603 may be configured to correlate the obtained UHI and the obtained further UHI based on one or more of the following:
the time stamp in the UHI;
the optional time stamp that is only used when a time UE stayed in cell-information element, IE, exceeds the predetermined range;
the repeating entries on exceeding a range of time UE stayed in cell-IE;
the optional time stamp that is only used when the time UE stayed in cell-IE exceeds the predetermined range and a SN release time; and
the time UE stayed in cell extended-IE with an extended range.

The MN 12 may be configured to add the time stamp in the UHI; the optional time stamp that is only used when a time UE stayed in cell-IE exceeds the predetermined range; the repeating entries on exceeding a range of time UE stayed in cell-IE; the optional time stamp that is only used when the time UE stayed in cell-IE exceeds the predetermined range and a SN release time; and/or the time UE stayed in cell extended-IE with the extended range.

Thus, depending on which the MN 12 may be configured to add these time stamp, optional time stamp, repeating entries, and/or new IE when collecting the UHIs (shown in dashed boxes in action 401 and 402). The obtained further UHI comprises the time stamp in the further UHI; the optional time stamp that is only used when a time UE stayed in cell-IE exceeds the predetermined range; the repeating entries on exceeding a range of time UE stayed in cell-IE; the optional time stamp that is only used when the time UE stayed in cell-IE exceeds the predetermined range and a SN release time; and/or the time UE stayed in cell extended-IE with the extended range. Thus, the obtained UHIs may comprise time stamp, optional time stamp, repeating entries, and/or new IE.

The MN 12 may comprise a performing unit 604, e.g., a scheduler, a transmitter, or a transceiver. The MN 12, the processing circuitry 601, and/or the performing unit 604 may be configured to use the correlated list for handling communication of the UE 10. The MN 12, the processing circuitry 601, and/or the performing unit 604 may be configured to use the correlated list by deciding whether to perform dual connectivity or not for the UE 10 based on the correlated list. The MN 12, the processing circuitry 601, and/or the performing unit 604 may be configured to provide the correlated list to another network node for handling mobility of the UE (10).

The MN 12, the processing circuitry 601, and/or the performing unit 604 may be configured to use or provide the correlated list for handling communication, such as mobility, DC or similar, for one or more UEs.

The MN 12 further comprises a memory 607. The memory comprises one or more units to be used to store data on, such as indications, time stamps, correlated lists, priorities, RSs, strengths or qualities, UL grants, indications, requests, commands, timers, applications to perform the methods disclosed herein when being executed, and similar. Thus, the MN may comprise the processing circuitry and the memory, said memory comprising instructions executable by said processing circuitry whereby said MN is operative to perform the methods herein. The MN 12 comprises a communication interface 608 comprising transmitter, receiver, transceiver and/or one or more antennas.

The methods according to the embodiments described herein for the MN 12 are respectively implemented by means of e.g. a computer program product 605 or a computer program, comprising instructions, i.e., software code portions, which, when executed on at least one processor, cause the at least one processor to carry out the actions described herein, as performed by the MN 12. The computer program product 605 may be stored on a computer-readable storage medium 606, e.g. a universal serial bus (USB) stick, a disc or similar. The computer-readable storage medium 606, having stored thereon the computer program product, may comprise the instructions which, when executed on at least one processor, cause the at least one processor to carry out the actions described herein, as performed by the MN 12. In some embodiments, the computer-readable storage medium may be a non-transitory or a transitory computer-readable storage medium.

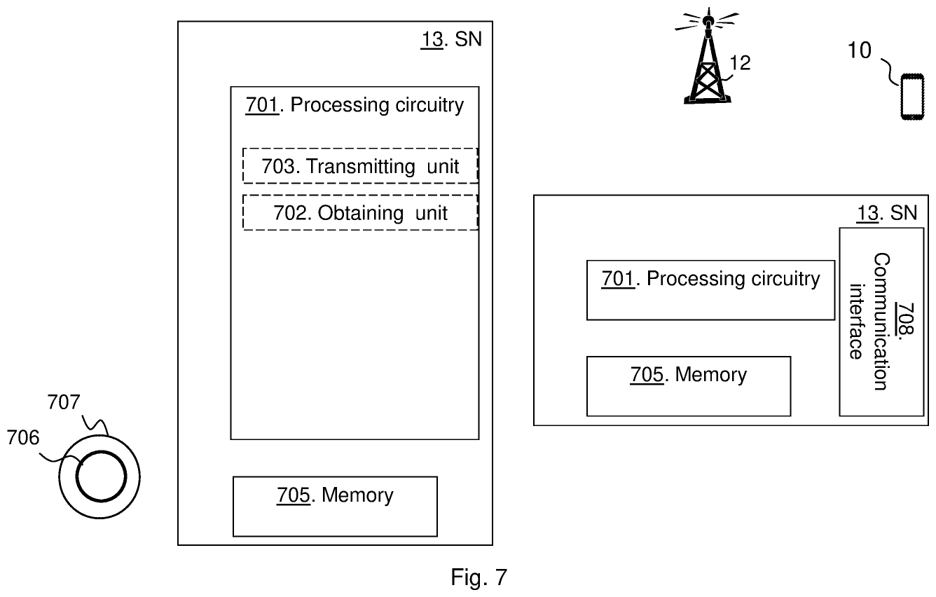

FIG. 7 is a block diagram depicting the SN 13, in two embodiments, for handling communication, e.g. handling UHIs in the wireless communication network 1 according to embodiments herein.

The SN 13 may comprise processing circuitry 701, e.g. one or more processors, configured to perform the methods herein.

The SN 13 may comprise an obtaining unit 702, e.g. a receiver or a transceiver.

The SN 13, the processing circuitry 701 and/or the receiving unit 702 is configured to obtain the UHI related to the connected PSCell of the UE 10. Thus, the SN 13, the processing circuitry 701 and/or the obtaining unit 702 may be configured to obtain UHIs of connected PCells and PSCells for one or more UEs.

The SN 13 may be configured to add the time stamp in the UHI; the optional time stamp that is only used when a time UE stayed in cell-IE exceeds the predetermined range; the repeating entries on exceeding a range of time UE stayed in cell-IE; the optional time stamp that is only used when the time UE stayed in cell-IE exceeds the predetermined range and a SN release time; and/or the time UE stayed in cell extended-IE with the extended range.

The SN 13 may comprise a transmitting unit 703, e.g. a transmitter or a transceiver. The SN 13, the processing circuitry 701 and/or the transmitting unit 703 is configured to provide to the MN 12 the obtained UHI for the UE 10. The SN 13, the processing circuitry 701 and/or the transmitting unit 703 may be configured to transmit/provide the UHI for one or more UEs comprising time stamp, optional time stamp, repeating entries, and/or new IE. The UHI may comprise one or more of the following:
the time stamp in the UHI;
the optional time stamp that is only used when a time UE stayed in cell-information element, IE, exceeds the predetermined range;
the repeating entries on exceeding a range of time UE stayed in cell-IE;
the optional time stamp that is only used when the time UE stayed in cell-IE exceeds the predetermined range and a SN release time; and
the time UE stayed in cell extended-IE with an extended range.

The SN 13 further comprises a memory 705. The memory comprises one or more units to be used to store data on, such as indications, time stamps, UHI, strengths or qualities, grants, scheduling information, timers, applications to perform the methods disclosed herein when being executed, and similar. Thus, the SN may comprise the processing circuitry and the memory, said memory comprising instructions executable by said processing circuitry whereby said SN is operative to perform the methods herein.

The SN 13 comprises a communication interface 708 comprising transmitter, receiver, transceiver and/or one or more antennas.

The methods according to the embodiments described herein for the SN 13 are respectively implemented by means of e.g. a computer program product 706 or a computer program product, comprising instructions, i.e., software code portions, which, when executed on at least one processor, cause the at least one processor to carry out the actions described herein, as performed by the SN 13. The computer program product 706 may be stored on a computer-readable storage medium 707, e.g. a USB stick, a disc or similar. The computer-readable storage medium 707, having stored thereon the computer program product, may comprise the instructions which, when executed on at least one processor, cause the at least one processor to carry out the actions described herein, as performed by the SN 13. In some embodiments, the computer-readable storage medium may be a non-transitory or transitory computer-readable storage medium.

In some embodiments a more general term “radio network node” is used and it can correspond to any type of radio network node or any network node, which communicates with a wireless device and/or with another network node. Examples of network nodes are NodeB, Master eNB, Secondary eNB, a network node belonging to Master cell group (MCG) or Secondary Cell Group (SCG), base station (BS), multi-standard radio (MSR) radio node such as MSR BS, eNodeB, network controller, radio network controller (RNC), base station controller (BSC), relay, donor node controlling relay, base transceiver station (BTS), access point (AP), transmission points, transmission nodes, Remote Radio Unit (RRU), Remote Radio Head (RRH), nodes in distributed antenna system (DAS), core network node e.g. Mobility Switching Centre (MSC), Mobile Management Entity (MME) etc., Operation and Maintenance (O&M), Operation Support System (OSS), Self-Organizing Network (SON), positioning node e.g. Evolved Serving Mobile Location Centre (E-SMLC), Minimizing Drive Test (MDT) etc.

In some embodiments the non-limiting term wireless device or user equipment (UE) is used and it refers to any type of wireless device communicating with a network node and/or with another UE in a cellular or mobile communication system. Examples of UE are target device, device-to-device (D2D) UE, proximity capable UE (aka ProSe UE), machine type UE or UE capable of machine to machine (M2M) communication, PDA, PAD, Tablet, mobile terminals, smart phone, laptop embedded equipped (LEE), laptop mounted equipment (LME), USB dongles etc.

The embodiments are described for 5G. However the embodiments are applicable to any RAT or multi-RAT systems, where the UE receives and/or transmit signals (e.g. data) e.g. LTE, LTE FDD/TDD, WCDMA/HSPA, GSM/GERAN, Wi Fi, WLAN, CDMA2000 etc.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communications devices will appreciate the cost, performance, and maintenance trade-offs inherent in these design choices.

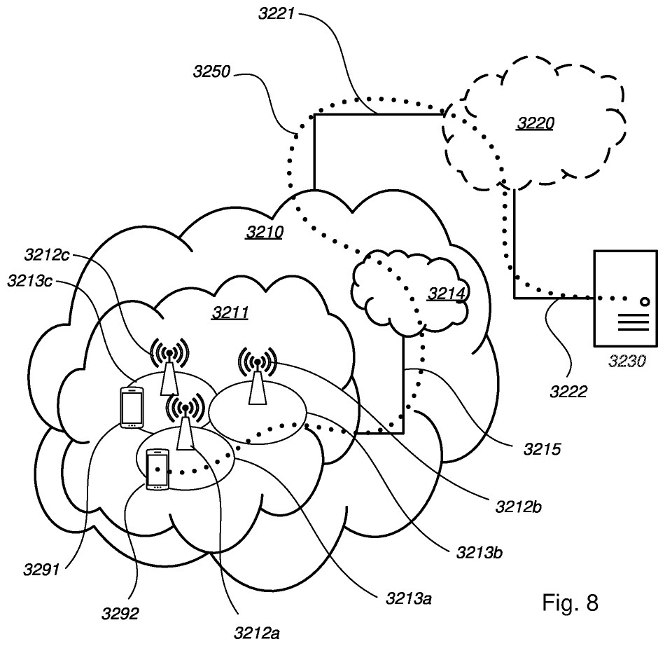

With reference to FIG. 8, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 8 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

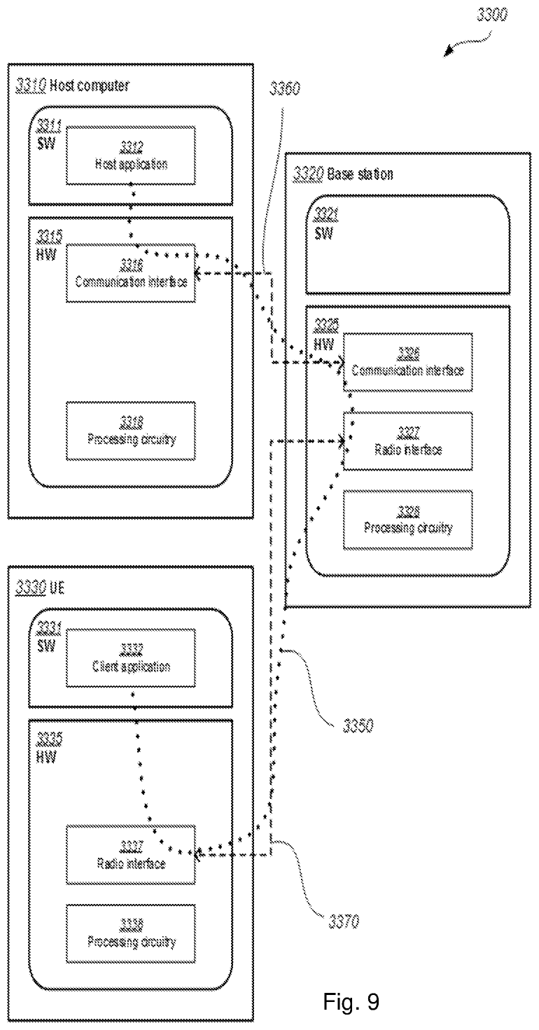

Example implementations, in accordance with an embodiment, of the UE, base station and host computer discussed in the preceding paragraphs will now be described with reference to FIG. 9. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 9) served by the base station 3320. The communication interface 3326 may be configured to facilitate a connection 3360 to the host computer 3310. The connection 3360 may be direct or it may pass through a core network (not shown in FIG. 9) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 9 may be identical to the host computer 3230, one of the base stations 3212a, 3212b, 3212c and one of the UEs 3291, 3292 of FIG. 8, respectively. This is to say, the inner workings of these entities may be as shown in FIG. 9 and independently, the surrounding network topology may be that of FIG. 8.

In FIG. 9, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since mobility may be handled more efficiently and thereby provide benefits such as reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

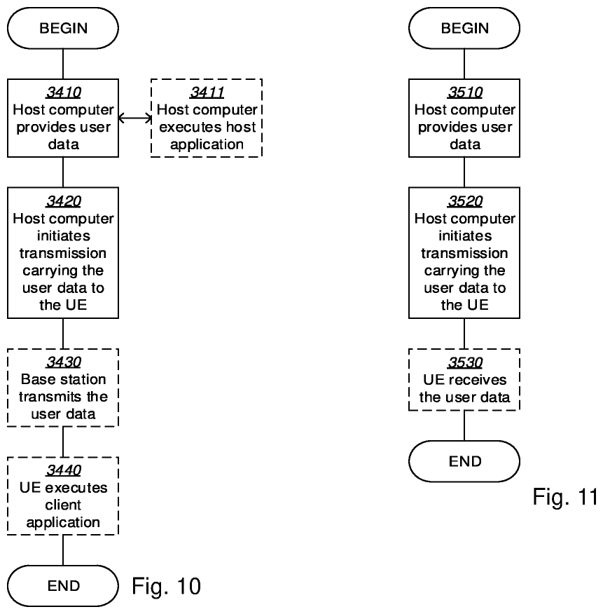

FIG. 10 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 10 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 11 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 11 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

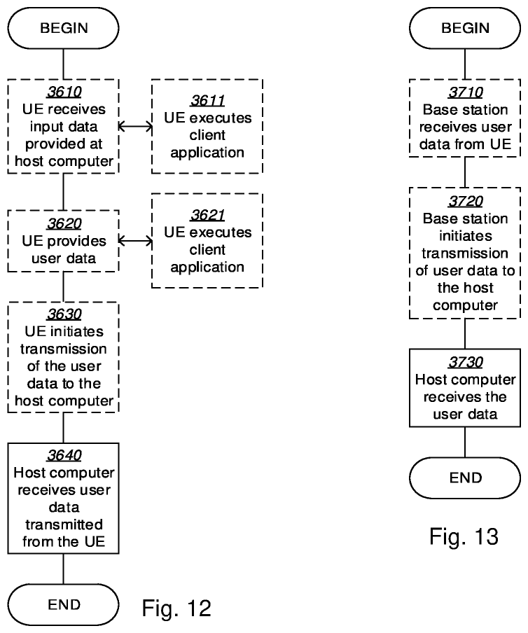

FIG. 12 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 12 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 13 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 13 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1-22. (canceled)

23. A method performed by a master node for handling communication in a wireless communication network, the method comprising:
obtaining user equipment history information (UHI) related to a primary cell (PCell) of a user equipment (UE);
obtaining, from a secondary node further UHI related to a connected primary secondary cell (PSCell) of the UE;
correlating the obtained UHI and the obtained further UHI into a list of related PCells and PSCells.

24. The method of claim 23, wherein correlating is based on one or more of the following:
a time stamp in the UHIs;
an optional time stamp that is only used when a time UE stayed in cell-information element (IE) exceeds the predetermined range;
repeating entries on exceeding a range of time UE stayed in cell-IE;
an optional time stamp that is only used when the time UE stayed in cell-IE exceeds the predetermined range and a SN release time; and
a time UE stayed in cell extended-IE with an extended range.

25. The method of claim 24, further comprising
adding the time stamp in the UHI; the optional time stamp that is only used when a time UE stayed in cell-IE exceeds the predetermined range; the repeating entries on exceeding a range of time UE stayed in cell-IE; the optional time stamp that is only used when the time UE stayed in cell-IE exceeds the predetermined range and a SN release time; and/or the time UE stayed in cell extended-IE with the extended range.

26. The method of claim 24, wherein the obtained further UHI comprises the time stamp in the further UHI; the optional time stamp that is only used when a time UE stayed in cell-IE exceeds the predetermined range; the repeating entries on exceeding a range of time UE stayed in cell-IE; the optional time stamp that is only used when the time UE stayed in cell-IE exceeds the predetermined range and a SN release time; and/or the time UE stayed in cell extended-IE with the extended range.

27. The method of claim 23, further comprising
using the correlated list for handling communication of the UE.

28. The method of claim 27, wherein using comprises deciding whether to perform dual connectivity or not for the UE based on the correlated list.

29. The method of claim 23, further comprising
providing the correlated list to another network node for handling mobility of the UE.

30. A method performed by a secondary node for handling communication in a wireless communication network, the method comprising:
obtaining user equipment history information (UHI) related to a connected primary secondary cell (PSCell) of a user equipment, UE; and
providing to a master node the obtained UHI for the UE.

31. The method of claim 30, wherein the UHI comprises one or more of the following:
a time stamp in the UHI;
an optional time stamp that is only used when a time UE stayed in cell-information element (IE) exceeds the predetermined range;
repeating entries on exceeding a range of time UE stayed in cell-IE;
an optional time stamp that is only used when the time UE stayed in cell-IE exceeds the predetermined range and a SN release time; and
a time UE stayed in cell extended-IE with an extended range.

32. The method of claim 31, further comprising
adding the time stamp in the UHI; the optional time stamp that is only used when a time UE stayed in cell-IE exceeds the predetermined range; the repeating entries on exceeding a range of time UE stayed in cell-IE; the optional time stamp that is only used when the time UE stayed in cell-IE exceeds the predetermined range and a SN release time; and/or the time UE stayed in cell extended-IE with the extended range.

33. A master node for handling communication in a wireless communication network, wherein the master node comprises communication interface circuitry and processing circuitry configured to:
obtain user equipment history information (UHI) related to a primary cell (PCell) of a user equipment (UE);
obtain from a secondary node further UHI related to a connected primary secondary cell, (PSCell) of the UE;
correlate the obtained UHI and the obtained further UHI into a list of related PCells and PSCells.

34. The master node of claim 33, wherein the processing circuitry is configured to correlate the obtained UHI and the obtained further UHI based on one or more of the following:
a time stamp in the UHI;
an optional time stamp that is only used when a time UE stayed in cell-information element (IE) exceeds the predetermined range;
repeating entries on exceeding a range of time UE stayed in cell-IE;
an optional time stamp that is only used when the time UE stayed in cell-IE exceeds the predetermined range and a SN release time; and
a time UE stayed in cell extended-IE with an extended range.

35. The master node of claim 34, wherein the processing circuitry is configured to
add the time stamp in the UHI; the optional time stamp that is only used when a time UE stayed in cell-IE exceeds the predetermined range; the repeating entries on exceeding a range of time UE stayed in cell-IE; the optional time stamp that is only used when the time UE stayed in cell-IE exceeds the predetermined range and a SN release time; and/or the time UE stayed in cell extended-IE with the extended range.

36. The master node of claim 34, wherein the obtained further UHI comprises the time stamp in the further UHI; the optional time stamp that is only used when a time UE stayed in cell-IE exceeds the predetermined range; the repeating entries on exceeding a range of time UE stayed in cell-IE; the optional time stamp that is only used when the time UE stayed in cell-IE exceeds the predetermined range and a SN release time; and/or the time UE stayed in cell extended-IE with the extended range.

37. The master node of claim 33, wherein the processing circuitry is further configured to use the correlated list for handling communication of the UE.

38. The master node of claim 37, wherein the processing circuitry is configured to use the correlated list by deciding whether to perform dual connectivity or not for the UE based on the correlated list.

39. The master node of claim 33, wherein the processing circuitry is configured to provide the correlated list to another network node for handling mobility of the UE.

40. A secondary node for handling communication in a wireless communication network, wherein the secondary node comprises communication interface circuitry and processing circuitry configured to:
obtain user equipment history information (UHI) related to a connected primary secondary cell (PSCell) of a user equipment (UE); and
provide to a master node the obtained UHI for the UE.

41. The secondary node of claim 40, wherein the UHI comprises one or more of the following:
a time stamp in the UHI;
an optional time stamp that is only used when a time UE stayed in cell-information element (IE) exceeds the predetermined range;
repeating entries on exceeding a range of time UE stayed in cell-IE;
an optional time stamp that is only used when the time UE stayed in cell-IE exceeds the predetermined range and a SN release time; and
a time UE stayed in cell extended-IE with an extended range.

42. The secondary node of claim 41, wherein the processing circuitry is further configured to
add the time stamp in the UHI; the optional time stamp that is only used when a time UE stayed in cell-IE exceeds the predetermined range; the repeating entries on exceeding a range of time UE stayed in cell-IE; the optional time stamp that is only used when the time UE stayed in cell-IE exceeds the predetermined range and a SN release time; and/or the time UE stayed in cell extended-IE with the extended range.
